(19) United States
(12) Patent Application Publication
(10) Pub. No.: US 2023/0153922 A1
(43) Pub. Date: May 18, 2023

(54) SYSTEMS AND METHODS FOR NETWORKING EDUCATION, DEVELOPMENT, AND MANAGEMENT

(71) Applicant: keepwith, LLC, Mt. Prospect, IL (US)

(72) Inventor: Megan Burke Roudebush, Mount Prospect, IL (US)

(21) Appl. No.: 18/055,608

(22) Filed: Nov. 15, 2022

Related U.S. Application Data
(60) Provisional application No. 63/279,981, filed on Nov. 16, 2021.

(51) Int. Cl. G06Q 50/00; G06N 3/08; G06F 40/30

(52) U.S. Cl. CPC G06Q 50/01; G06N 3/08; G06F 40/30

(57) ABSTRACT

A method includes obtaining a plurality of user accounts each including a user profile, a network strategy, and plurality of primary connections. Each primary connection defines a primary relationship between a respective user account and a different user account. The method also includes determining a target user account from the plurality of user accounts and identifying a first user account using one of the plurality of primary connections of the target user account. The method also includes determining a second user account using one of the plurality of primary connections of the first user account. Here, the second user account lacks a primary relationship with the target user account. The method also includes generating a networking recommendation based on text corresponding to the target user account and text corresponding to the second user account. The method also includes transmitting a notification including the networking recommendation to a user device.

### CROSS REFERENCE TO RELATED APPLICATIONS

This U.S. Patent application claims priority under 35 U.S.C. § 119(e) to U.S. Provisional Application 63/279,981, filed on Nov. 16, 2021. The disclosure of this prior application is considered part of the disclosure of this application and is hereby incorporated by reference in its entirety.

### TECHNICAL FIELD

This disclosure relates to systems and methods for networking education, development, and management.

### BACKGROUND

Social media and networking applications maintain a significant amount of information on companies, organizations, employees, and other users of these applications. As popularity of these networking applications increases, users have unprecedented access to connect and/or communicate with a vast number of users (e.g., over one million users) previously unavailable to them. Unfortunately, this also results in some users receiving unsolicited communications or connection requests from random users (e.g., spam accounts) providing little or no networking benefit to them. These unsolicited communications have become more burdensome to users of these networking applications thereby reducing overall user satisfaction. Thus, facilitating beneficial and meaningful relationships on a spam-free and advertisement-free platform would thereby increase the overall user satisfaction for these networking applications.

### SUMMARY

One aspect of the disclosure provides a computer-implemented method that when executed on data processing hardware causes the data processing hardware to perform operations for generating networking recommendations for a plurality of user accounts of a platform (e.g., a networking or social media platform such as a keepwith platform). The operations include obtaining a plurality of user accounts. Each respective user account includes a user profile, a network strategy, and a plurality of primary connections. The network strategy includes at least one of current connections, candidate connections, network goals, networking tasks, networking events, networking introductions, candidate introductions, and an ability to invite users to the platform. Each primary connection defines a primary relationship between the respective user account and a different user account of the plurality of user accounts. The operations also include determining a target user account from the plurality of user accounts and identifying a first user account using one of the plurality of primary connections of the target user account. The operations also include determining a second user account using one of the plurality of primary connections of the first user account. Here, the second user account lacks a primary relationship with the target user account. The operations also include generating a networking recommendation based on text corresponding to the network goal of the target user account and text corresponding to the second user account. The operations also include transmitting a notification that includes the networking recommendation to the user device associated with the first user account.

Implementations of the disclosure may include one or more of the following optional features. In some implementations, the operations further include transmitting the notification including the networking recommendation to a user device associated with the target user account. The networking recommendation may include a recommendation for a user associated with the first user account to initiate an introduction between a user associated with the target user account and a user associated with the second user account.

In some examples, the operations further include receiving, from the user device associated with the first user account, an introduction request to initiate the introduction between the user associated with the target user account and the user associated with the second user account and transmitting the introduction request to a user device associated with the target user account and a user device associated with the second user account. In these examples, the operations may further include receiving an affirmative response from both the user device associated with the target user account and the user device associated with the second user account and generating a primary connection between the target user account and the second user account based on receiving the affirmative responses from both the user device associated with the target user account and the user device associated with the second user account. The operations may further include receiving at least one negative response from either the user device associated with the target user account or the user device associated with the second user account and determining not to generate a primary connection between the target user account and the second user account based on receiving the at least one negative response from either the user device associated with the target user account or the user device associated with the second user account.

In some implementations, determining the networking recommendation includes generating a target natural language processing (NLP) output corresponding to the text of the network goal of the target user account using a neural network model, generating candidate NLP output corresponding to the text of the second user account using the neural network model, and determining a matching score using the targeting NLP output and the candidate NLP output. In these implementations, the operations may further include determining that the matching score satisfies a matching score threshold and transmitting the notification including the networking recommendation based on determining that the matching score satisfies the matching score threshold. The operations may further include training a neural network model. In some examples, each respective user account of the plurality of user accounts further includes a plurality of spheres of influence. In these examples, each respective sphere of influence includes at least one primary connection of the plurality of primary connections, a classification representing a connection type of each primary connection of the at least one primary connections, and a ranking indicating a connection strength for each respective primary connection of the at least one primary connection.

Another aspect of the disclosure provides a system that includes data processing hardware and memory hardware storing instructions that when executed on the data processing hardware causes the data processing hardware to perform operations. The operations include obtaining a plurality of user accounts. Each respective user account includes a user profile, a network strategy, and a plurality of primary connections. The network strategy includes at least one of current connections, candidate connections, network goals, networking tasks, networking events, networking introductions, candidate introductions, and an ability to invite users to the platform. Each primary connection defines a primary relationship between the respective user account and a different user account of the plurality of user accounts. The operations also include determining a target user account from the plurality of user accounts and identifying a first user account using one of the plurality of primary connections of the target user account. The operations also include determining a second user account using one of the plurality of primary connections of the first user account. Here, the second user account lacks a primary relationship with the target user account. The operations also include generating a networking recommendation based on text corresponding to the network goal of the target user account and text corresponding to the second user account. The operations also include transmitting a notification that includes the networking recommendation to the user device associated with the first user account.

Implementations of the disclosure may include one or more of the following optional features. In some implementations, the operations further include transmitting the notification including the networking recommendation to a user device associated with the target user account. The networking recommendation may include a recommendation for a user associated with the first user account to initiate an introduction between a user associated with the target user account and a user associated with the second user account.

In some examples, the operations further include receiving, from the user device associated with the first user account, an introduction request to initiate the introduction between the user associated with the target user account and the user associated with the second user account and transmitting the introduction request to a user device associated with the target user account and a user device associated with the second user account. In these examples, the operations may further include receiving an affirmative response from both the user device associated with the target user account and the user device associated with the second user account and generating a primary connection between the target user account and the second user account based on receiving the affirmative responses from both the user device associated with the target user account and the user device associated with the second user account. The operations may further include receiving at least one negative response from either the user device associated with the target user account or the user device associated with the second user account and determining not to generate a primary connection between the target user account and the second user account based on receiving the at least one negative response from either the user device associated with the target user account or the user device associated with the second user account.

In some implementations, determining the networking recommendation includes generating a target natural language processing (NLP) output corresponding to the text of the network goal of the target user account using a neural network model, generating candidate NLP output corresponding to the text of the second user account using the neural network model, and determining a matching score using the targeting NLP output and the candidate NLP output. In these implementations, the operations may further include determining that the matching score satisfies a matching score threshold and transmitting the notification including the networking recommendation based on determining that the matching score satisfies the matching score threshold. The operations may further include training a neural network model. In some examples, each respective user account of the plurality of user accounts further includes a plurality of spheres of influence. In these examples, each respective sphere of influence includes at least one primary connection of the plurality of primary connections, a classification representing a connection type of each primary connection of the at least one primary connections, and a ranking indicating a connection strength for each respective primary connection of the at least one primary connection.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for a networking application.

FIGS. 2A-2K are various graphical user interface views of a user account.

FIG. 3 is a schematic view of an example connection identifier.

FIGS. 4A and 4B are schematic views of an example neural network.

FIGS. 5A and 5B are schematic views of an example sequence diagram for generating a primary connection between a target user account and a second user account.

FIG. 6 is a schematic view of another example sequence diagram for generating a primary connection between a target user account and a second user account.

FIG. 7 is a flow chart of an example arrangement of operations for a computer-implemented method of generating a networking recommendation for a user account.

FIG. 8 is a schematic view of an example computing device that may be used to implement the systems and methods described herein.

Like reference symbols in the various drawings indicate like elements.

### DETAILED DESCRIPTION

Networking applications have increased in popularity allowing users to significantly expand their network by accessing a vast number of other users on these platforms. Current networking applications allow users to request a connection with any other user they encounter on the platform. In fact, these applications often emphasize users to connect with as many other users as possible, without truly knowing the other users or having any sort of shared interests. Thus, this approach does not emulate an in-person networking environment where making networking connections with other people usually includes a shared interest or a mutual connection. That is, in the in-person networking environment, oftentimes a mutual connection between two people who do not know one another will make an introduction between the two people. In particular, the mutual connection will make the introduction if they believe the two people have some shared interests. Moreover, since the mutual connection initiates the introduction, there is a credibility associated with the introduction that is not otherwise present in the approach of current networking applications.

Accordingly, implementations herein are directed to systems and methods for networking education, development, and management. More specifically, a networking application obtains a plurality of user accounts each including a network goal and a plurality of primary connections. Each primary connection defines a primary relationship between a respective user profile and a different user profile. The networking application includes a connection identifier that identifies a first user account using one of the plurality of primary connections of a target user account. The connection identifier also determines a second user account using one of the plurality of primary connections of the first user account. Here, the second user account lacks a primary relationship with the target user account.

The networking application also includes a neural network that generates (or does not generate) a networking recommendation based on text corresponding to the target user account and text corresponding to the second user account. That is, the neural network applies natural language processing (NLP) to understand the text of the profiles and determine whether users associated with the profiles would be a good networking match. When the neural network generates the networking recommendation, the networking application transmits a notification including the networking recommendation to a user device. As will become apparent, the user associated with the first user account (e.g., mutual connection) may decide whether to initiate a connection between user associated with the target user account and the second user account. Moreover, both the user associated with the target user account and the user associated with the second user account must consent to the connection before a primary relationship is established between them.

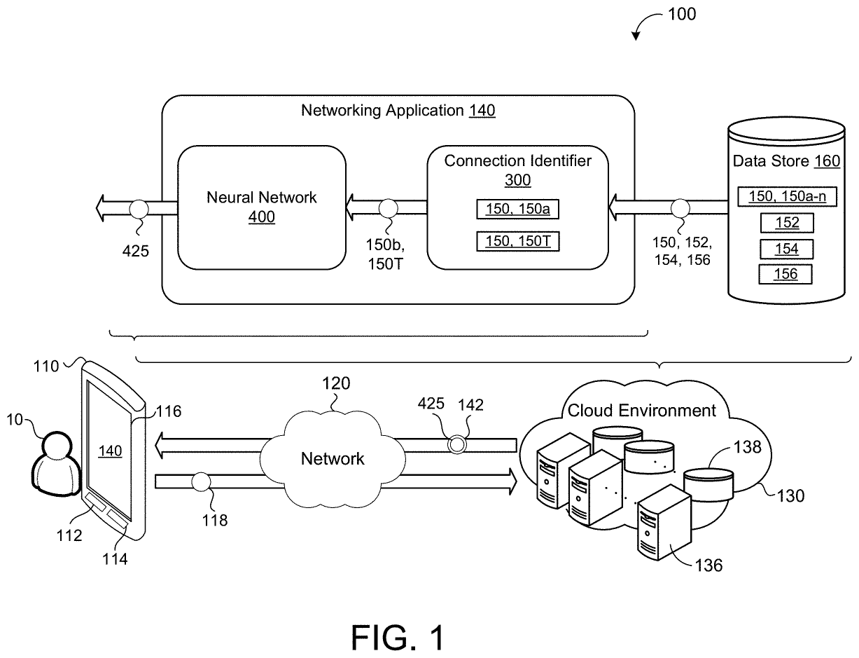

Referring to FIG. 1, in some implementations, an example system 100 includes one or more user devices 110 each associated with a respective user 10 and in communication with a cloud computing environment 130 via a network 120. Moreover, each user device 110 may be in communication with each other user device 110 via the network 120. Each user device 110 may correspond to a computing device, such as, without limitation, a desktop workstation, a laptop workstation, or a mobile computing device (e.g., smart phone, tablet, or wearable device), and includes data processing hardware 112 and memory hardware 114. The cloud computing environment 130 may be a single computer, multiple computers, or a distributed system having scalable/elastic resources, such as processing resources 136 (e.g., data processing hardware) and/or storage resources 138 (e.g., memory hardware). In some implementations, the user device 110 includes a screen 116 with a graphical user interface (GUI) to display a networking application 140 executing on the user device 110. In some examples, the screen 116 of the user device 110 includes a touch screen 116 configured to receive touch inputs from the user 10 to select content displayed on the screen 116 and/or to execute some functionality associated with an area receiving the touch input.

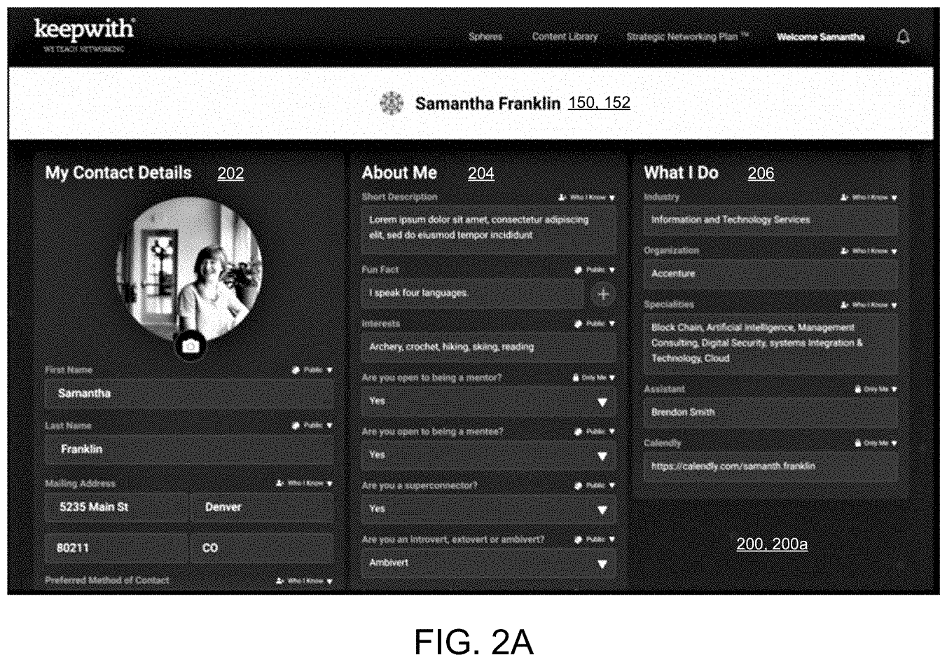

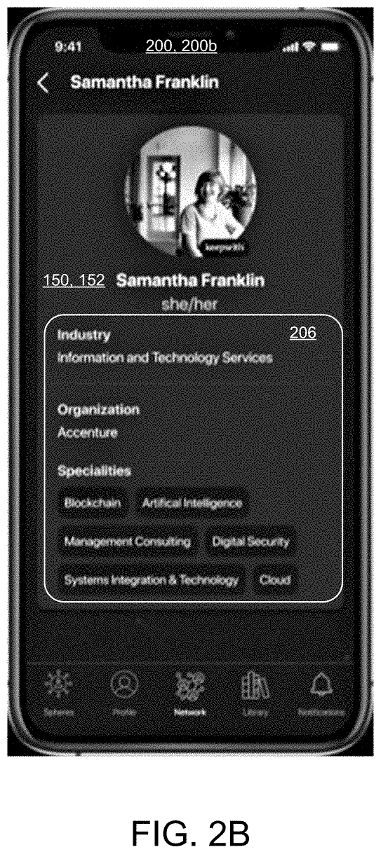

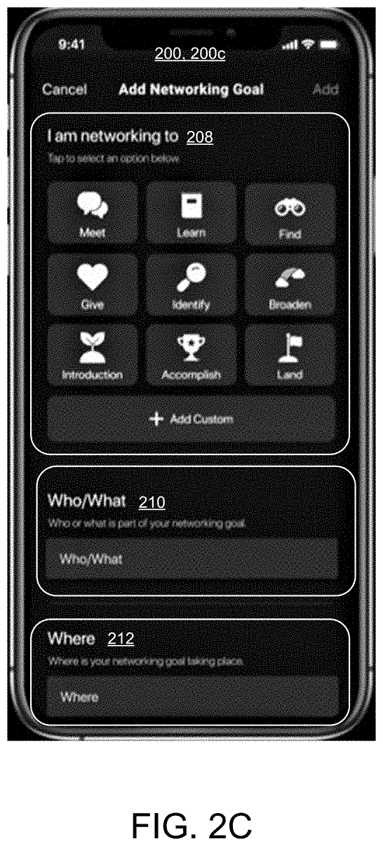

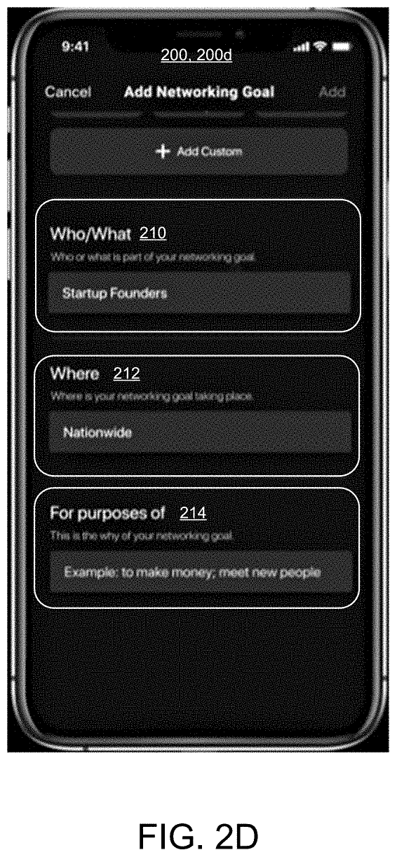

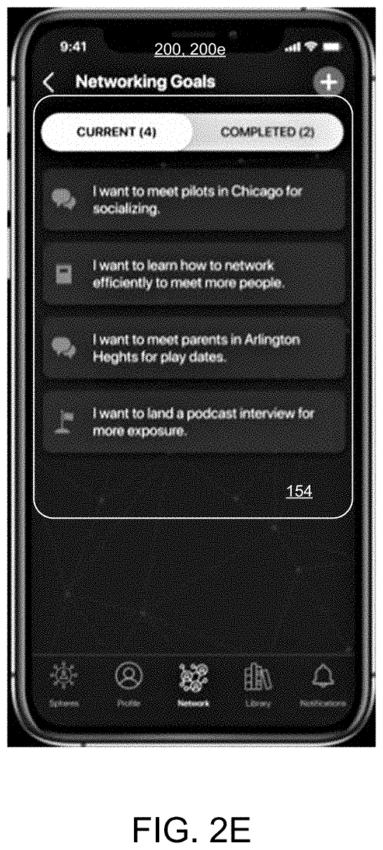

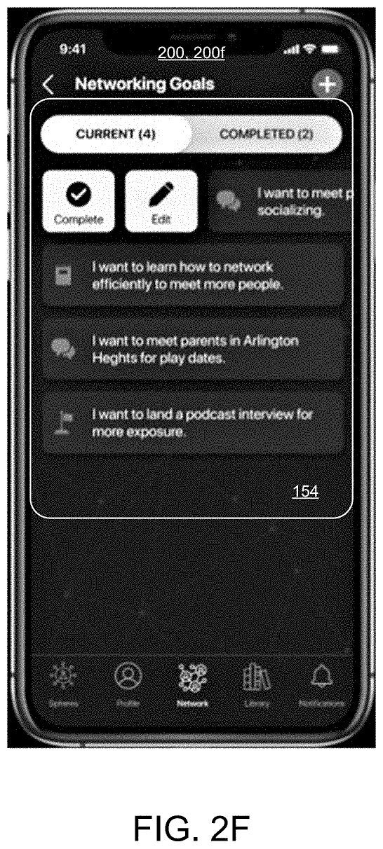

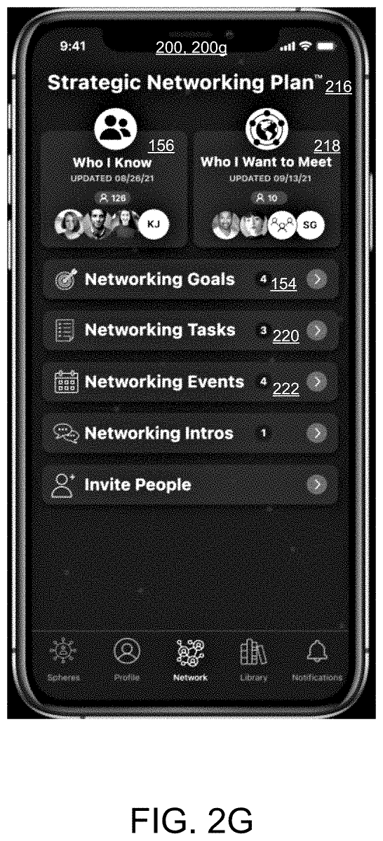

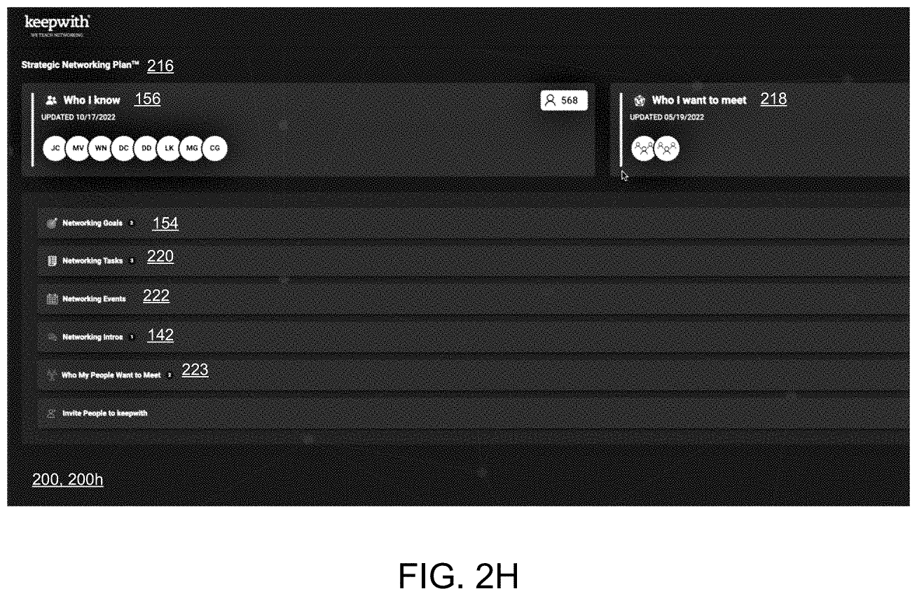

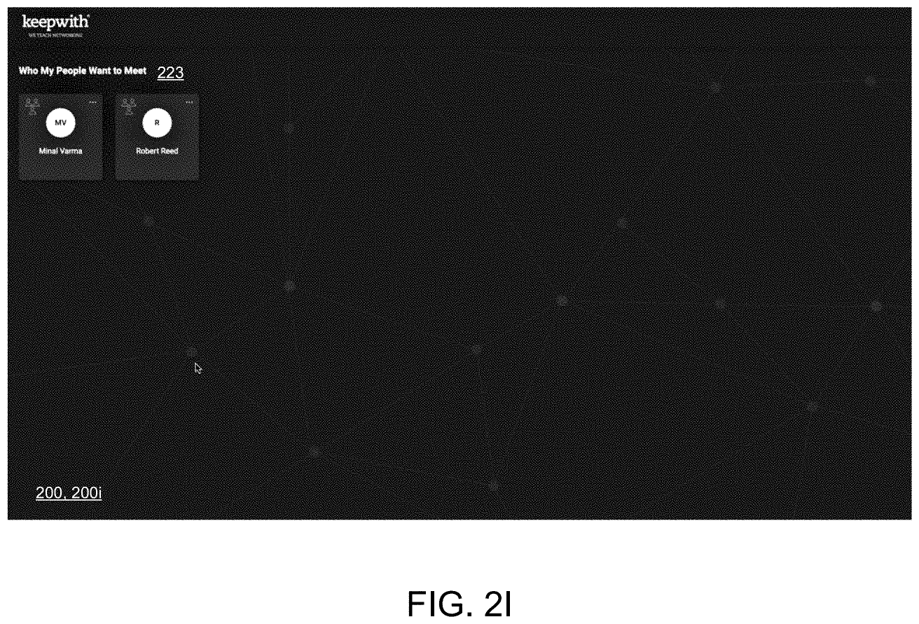

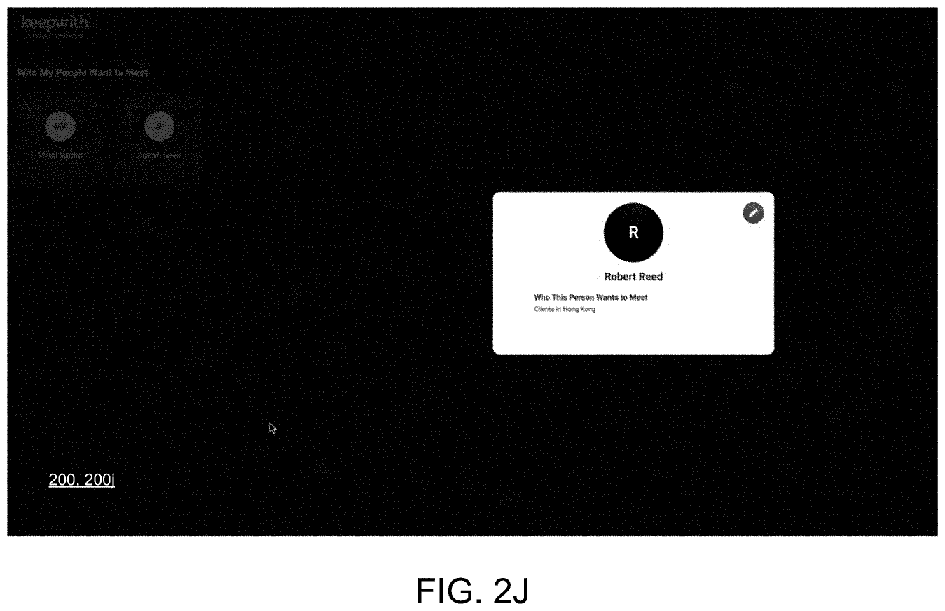

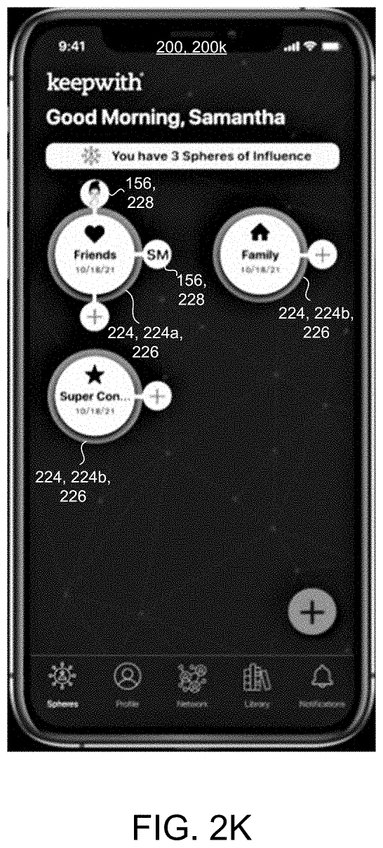

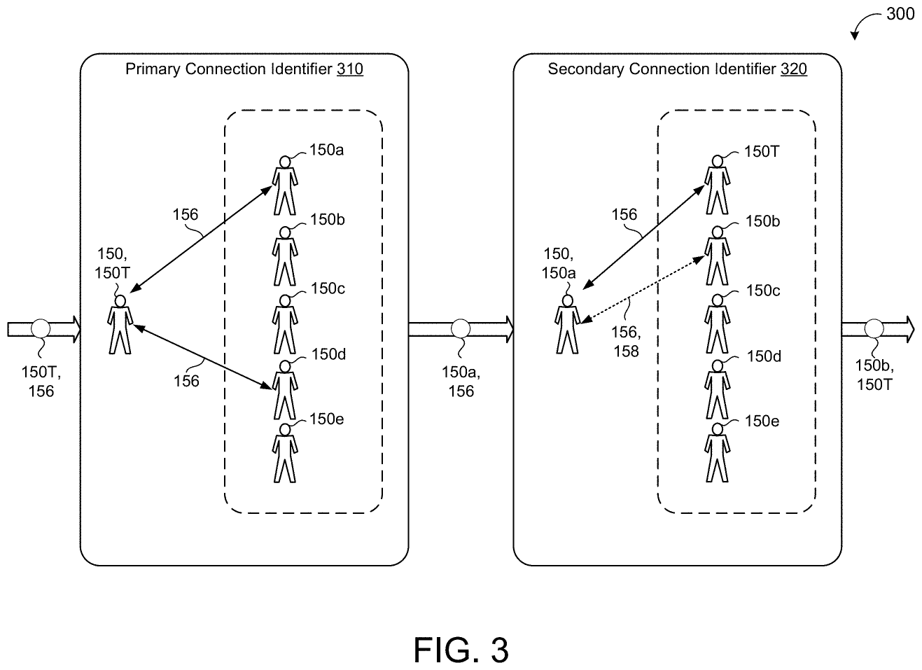

In some implementations, the networking application 140 executes at the cloud computing environment 130 in addition to, or in lieu of, executing at the user device 110. The networking application 140 includes a connection identifier 300 and a neural network 400. The connection identifier 300 obtains a plurality of user accounts 150, 150a-n from a data store 160. The data store 160 may be overlain on the storage resources 138 to allow scalable use of the storage resources 138. Each respective user account 150 is associated with a corresponding user 10. The user 10 may represent an individual person or an entity such as a business or non-profit organization. Moreover, each respective user account 150 includes a user profile 152, a network objective 154, and a plurality of primary connections 156 described in greater detail with reference to FIGS. 2 and 3, respectively. Thus, the connection identifier 300 obtains the corresponding network objective 154 and the plurality of primary connections 156 in connection with each user account. The connection identifier 300 determines a target user account 150, 150T from the plurality of user accounts 150. The target user account 150T may be any one of the user accounts 150. As will become apparent, the connection identifier 300 identifies a first user account 150a using one of the plurality of primary connections 156 of a target user account 150T and determines a second user account 150, 150b using one of the plurality of primary connections 156 of the identified first user account 150a.

The neural network 400 receives the target user account 150T and the second user account 150b identified by the connection identifier 300 and generates (or does not generate) a networking recommendation 245 based on text corresponding to the target user account 150T and text corresponding to the second user account 150b. After generating the networking recommendation 245, the networking application 140 transmits a notification 142 that includes the networking recommendation 425 to the one or more user devices 110. In some instances, the networking application 140 transmits the notification 142 including the networking recommendation 245 to a user device 110 associated with the first user account 150a. Additionally or alternatively, the networking application 140 may transmit the notification 142 including the networking recommendation 245 to a user device 110 associated with the target user account 150T. In some implementations, the user device 110 transmits a loss 118 to the networking application 140 indicating a value of the networking recommendation 245. For example, the user 10 associated with the user device 110 may provide value of “4” for the loss 118 when rating how beneficial the networking recommendation 245 was for the user 10 on a scale of 1-5. The networking application 140 may use the loss 118 to train the neural network 400.

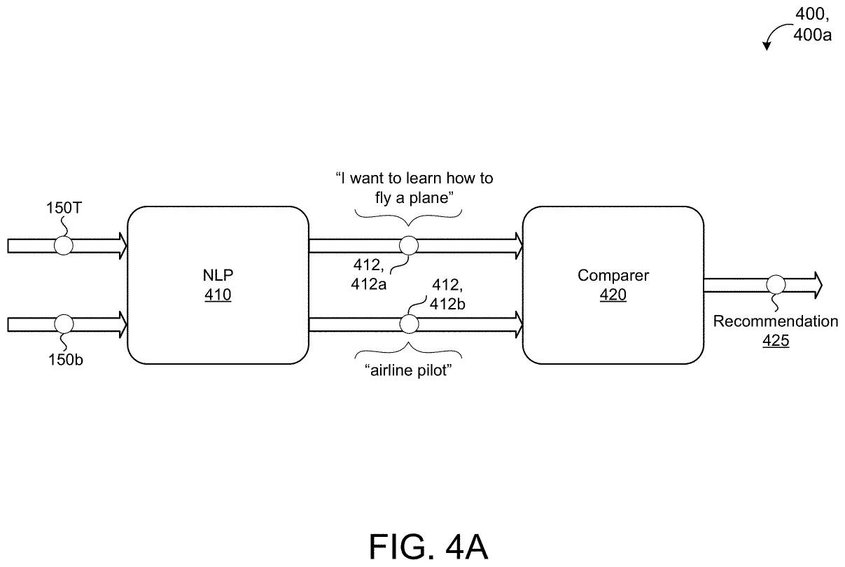

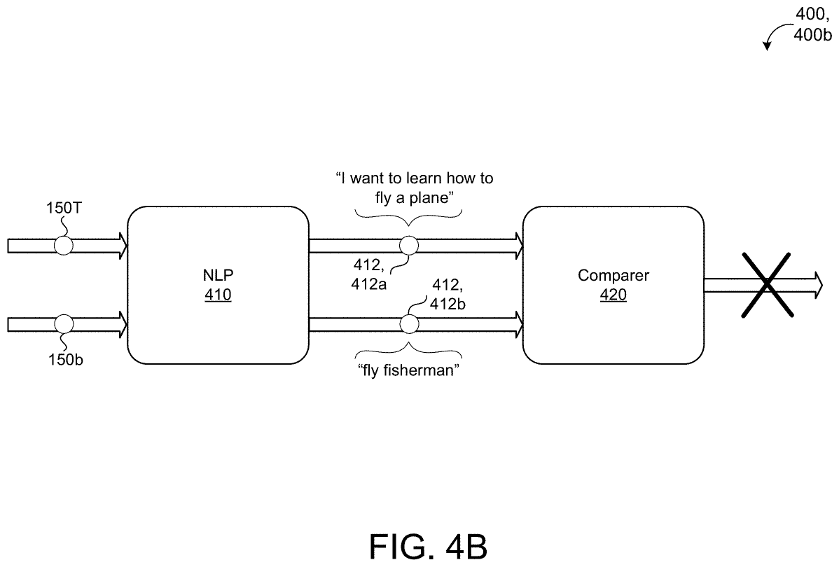

FIGS. 2A-2K show various GUI views 200 of an example user accounts 150 that may be displayed to a user 10 via the screen 116 of the user device 110 (FIG. 1). User accounts 150 (e.g., including associated user profile 152, network goal 154, and primary connections 156) may include any information shown in FIGS. 2A-2H and, as will become apparent, the neural network 400 (FIG. 4) may process text corresponding to this information. FIG. 2A shows an example GUI view 200, 200a of an expanded user account 150. Here, the user account 150 has a user profile 152 that includes information about the user including contact details 202, an “about me” section 204, and a “what I do” section 206. The contact details 202 may include a name, address, and preferred method of contact for the user. The preferred method of contact may include text, email, or in-application. Notably, if the preferred method of contact is text or email all communications sent by the networking application 140 go directly to the user via text or email whereby the user does not have to manage any in-application messages. Advantageously, by opting for text or email communications, the user does not have to manage a separate inbox of messages.

The “about me” section 204 may include a short description about the user, any fun facts about the user, interests of the user, whether the user is open to being a mentor or mentee, whether the user is a superconnector, or whether the user is an introvert, extrovert, or ambivert. The short description may include any text input by the user that provides a summary about the user. The fun fact may be anything not generally known to others about the user, for example, speaking four languages. Interests may include any interest the user is currently engaged in, or wishes to learn about. A superconnector is a user that maintains contact with thousands of people with various backgrounds.

The “what I do” section 206 includes professional information about the user. That is, professional information may include any industries the user has experience in, organizations the user has been involved with, any professional skills (specialties) the user has, and a link providing access to view and/or schedule a meeting with the user. For instance, the user may have experience in the information and technology services industry with one or more previous employers (organizations). Moreover, the user may have skills of block chain, artificial intelligence, management consulting, digital security, systems integrations and technology, and cloud computing.

On the other hand, FIG. 2B shows an example GUI view 200, 200b of a summarized user profile 152. Here, the example GUI view 200b conceals some of the information about the user as opposed to the example GUI view 200a (FIG. 2A). The GUI view 200b may be shown publicly to all users or to users without a primary relationship. In the example shown, the GUI view 200b only shows a portion of the “what I do” section 206 including industry information, organization information, and specialties.

FIGS. 2C and 2D shows example GUI views 200, 200c and 200, 200d, respectively. As shown, users may add networking objectives 154 (i.e., networking goals) to their user account 150. The network objectives 154 may include an objective type 208, an object 210, a location 212, and an outcome 214. The objective type 208 may include meeting someone, learning a skill, finding a person with certain characteristics, giving through monetary donations or knowledge and time, identifying an event of a particular type, broadening a skill, accomplishing a certain task, landing a position or role, or any other custom objective type 208. For example, learning a skill may include learning a new software application. Landing a position or role may include landing a new job in a different industry or landing a podcast interview. The object 210 of the network objective 154 may include a particular person the user wants to connect with. In some examples, the location 212 may be a city, state, or country associated with the network objective 154. For instance, the network objective 154 may be to meet new clients in Colorado. The outcome 214 (i.e., purpose) may be to increase sales or to meet new people.

FIGS. 2E and 2F shows example GUI views 200, 200e and 200, 200f, respectively. Here, the GUI views 200e, 200f show network objective 154 added to the user account including “I want to meet pilots in Chicago for socializing,” “I want to learn how to network efficiently to meet more people,” “I want to meet parents in Arlington Heights for play dates,” and “I want to land a podcast interview for more exposure.” The user may provide user input to edit or mark one of the network objectives 154 as complete. Moreover, the user may view current network objectives 154 and previously completed network objectives 154.

FIGS. 2G and 2H show an example GUI view 200, 200g, 200h including a networking strategy (i.e., strategic networking plan) 216 of the user account. In some examples, the networking strategy 216 will include the networking goals 154. The networking strategy 216 includes a list of the primary connections 156 of the user (e.g., who I know or current connections), a list of other user the user wants to meet (e.g., who I want to meet or candidate connections) 218, a list of network objectives 154 of the user, and networking tasks 220 and networking events 222 associated with the network objectives 154. Thus, the networking strategy 216 simply provides the user with an overview of current primary connections and steps (e.g., networking tasks 220 and networking events 222) to achieve the network objectives 154. The networking strategy may give the user an ability to invite users to the networking application (e.g., a keepwith platform) 140.

The networking strategy 216 (e.g., strategic networking plan) may also include candidate introductions (e.g., who my people want to meet) 223. FIGS. 21 and 2J show example GUI views 200, 200i, 200j including the candidate introductions 223. The candidate introductions 223 include other user accounts 150 the respective user account has a primary connection with and information on these other user accounts 150. For example, the candidate introductions 223 include information on a user account 150 of “Robert Reed” that a respective user account 150 has a primary relationship with. FIG. 2J shows information associated with user accounts Robert Reed is interested in meeting, for example, clients in Hong Kong.

FIG. 2K shows an example GUI view 200, 200k including a plurality of spheres of influence 224 of the user account 150. Each respective sphere of influence includes at least one primary connection 156 of the plurality of connections 156 with another user 10 of the plurality of users 10, a classification 226, and a ranking 228. For example, as shown in FIG. 2H the user account 150 includes three spheres of influence 224, 224a—c having a classification 226 of friends, family, and superconnectors, respectively. In this example, the friends classification 226 includes two primary connections 156 between the respective user account 150 and other user accounts 150. As such, the respective user account 150 identifies the two primary connections 156 as primary relationship with user accounts of friends of the respective user account 150.

Moreover, each primary connection 156 in the sphere of influence 224 includes the ranking 228 indicating a connection strength between the respective user account 150 and the other user account 150. For example, the user associated with the respective user account 150 may provide a ranking 228 of 0.9 for a first primary connection with a first user and a ranking 228 of 0.4 for a second primary connection with a second user. Here, the ranking 228 of 0.9 represents a greater connection strength between the user associated with the respective user account 150 and the first user as compared to the ranking 228 of 0.4 between the user associated with the respective user account 150 and the second user. Advantageously, the spheres of influence 224 allow users visualize different classifications 226 (e.g., connection type) and the corresponding ranking 228 for each primary connection 156 in the classification 226.

Referring now to FIG. 3, the connection identifier 300 obtains the plurality of user accounts 150 and determines the target user account 150T from among the plurality of user accounts 150. Each user account 150 includes a corresponding user profile 152, network goal 154, and one or more primary connections 156. The target user account 150T may be any user account 150 of the plurality of user accounts 150. The connection identifier 300 is configured to identify primary connections 156 and secondary connections 158 for the target user account 150T. Each primary connection 156 defines a primary relationship between two user accounts 150. The primary relationship is a direct connection between the two user accounts 150. The direct connection may include a connection between the two user accounts on the networking application 140 or a connection between the users of the two user accounts on another application of their respective user devices 110 (FIG. 1) such as a contact application or email application. On the other hand, each secondary connection 158 defines a secondary relationship between two user accounts 150. The secondary relationship defines both of the two user accounts having a shared primary relationship with another user accounts 150. Here, the two user accounts 150 lack a primary relationship with one another, but each user account 150 of the two user accounts 150 includes a respective primary relationship with common other user account 150.

The connection identifier 300 includes a primary connection identifier 310 and a secondary connection identifier 320. The primary connection identifier 310 may receive the target user account 150T and the plurality of primary connections 156 corresponding to the target user account 150T. Thus, the primary connection identifier 310 identifies one or more other user accounts 150 having a primary relationship with the target user account 150T using the corresponding plurality of primary connections 156. As shown in FIG. 3, the target user account 150T includes two primary connections 156 (e.g., denoted by the solid double arrow line) with other user accounts 150 of the plurality of users accounts 150, 150a-e. Namely, the target user account 150T includes a primary connection 156 with a first user account 150a and another primary connection 156 with a fourth user account 152d. The use of five user accounts 150 and two primary connections 156 is exemplary only, as it is understood that there may be any number of user accounts 150 in the plurality of user accounts 150 and any number of primary connections 156.

The secondary connection identifier 320 is configured to receive the user accounts 150 identified by the first connection identifier 320 as having a primary connection 156 with the target user account and determine secondary connections 158 for the target user account 150T. Continuing with the example above, the secondary connection identifier 320 receives the first user account 150a identified by the primary connection identifier 310 and determines a secondary connection 158 for the target user account 150T with a second user account 152, 150b. In particular, the secondary connection identifier 320 identifies the first user account 150a having a primary connection 156 with the target user account 150T (e.g., denoted by the solid double arrow line) and another primary connection 156 (e.g., denoted by the dotted double arrow line) with the second user account 150b. Using the primary connections 156 of the first user account 150a, the secondary connection identifier 320 determines that the second user account 150b lacks a primary relationship (e.g., primary connection 156) with the target user account 150T. As such, the dotted double arrow line indicates the primary connection 156 between the first and second user accounts 150a, 150b and the secondary connection 158 between the target user account 150T and the second user account 150b. Stated differently, because the target user account 150T and the second user account 150b lack a primary relationship with one another, but both have a shared primary relationship with the first user account 150a, the secondary connection 158 exists between the target user account 150T and the second user account 150b. The secondary connection identifier 320 transmits the second user account 150b and the target user account 150T to the neural network 400.

FIG. 3 shows the secondary connection identifier 320 determining secondary connections 158 for the target user account 150T using only one of the identified primary connections 156 (e.g., first user account 150a) of the target user account 150T for the sake of brevity only. That is, it is understood that the secondary connection identifier 320 would repeat this process for all other primary connections 156 (e.g., fourth user profile 152d) identified by the primary connection identifier 310. Moreover, it is understood that the connection identifier 300 would repeat this process for all target user accounts 150T (e.g., each user account 150 in the plurality of user accounts 150 that is determined as the target user account 150T)

Referring now to FIGS. 4A and 4B, the neural network 400 is configured to determine whether to generate a networking recommendation 425 to initiate an introduction between a user associated with the target user account 150T and a user associated with the second user account 150b. The neural network 400 includes a natural language processing (NLP) module 410 and a comparer 420. The NLP module 410 receives the target user account 150T and the second user account 150b, and generates corresponding NLP outputs 412. The NLP outputs 412 provide an understanding (e.g., semantic representation) corresponding to text of the user accounts 150 (e.g., text of the user profiles 152) for the neural network 400. Thus, the neural network 400 generates (or does not generate) the networking recommendation 425 based on comparing the NLP outputs 412. In some examples, the NLP module 410 generates multiple NLP outputs 412 for each user account 150. Here, each NLP output corresponds to a respective portion of text of the user account 150.

The NLP module 410 generates a target NLP output 412, 412a by applying NLP on text corresponding to the target user account 150T. For instance, the NLP module 410 may apply NLP on text corresponding to the user profile 152 and/or the network objective 154 of the target user account 150T. The NLP module 410 may generate multiple target NLP outputs 412a each corresponding to a different portion of text of the network objective 154. Moreover, the NLP module 410 generates a candidate NLP output 412, 412b by applying NLP on text corresponding to the second user account 150b.

The comparer is configured to receive, as input, the NLP outputs 412 generated by the NLP module 410 and generate (or refrain from generating), as output, the networking recommendation 425 based on comparing the NLP outputs 412. That is, using the NLP outputs 412 the comparer is able to understand from the semantic representations whether an introduction between the target user account 150T and the second user account 150b would be beneficial. In particular, the comparer 420 determines a matching score 422 using the target NLP output 412a and the candidate NLP output 412b. The matching score represents a likelihood that the user associated with the target user account 150T and the user associated with the second user account 150b would like to establish a primary relationship with one another. Stated differently, the matching score represents a similarity from the network objective 154 of the target user account 150T and the skills and information of the second user account 150b.

Thereafter, the comparer 420 determines whether the matching score satisfies a matching score threshold. In some examples, based on determining that the matching score satisfies the matching score threshold, the comparer 420 generates the networking recommendation 425. In other examples, based on determining that the matching score fails to satisfy the matching score threshold, the comparer 420 refrains from (e.g., does not) generate the networking recommendation 425.

As shown in FIG. 4A, the NLP module 410 of an example neural network model 400, 400a receives the target user account 150T and the second user account 150b (e.g., identified by the connection identifier 300 in FIG. 3). The NLP module 410 generates a target NLP output 412a corresponding to the target user account 200T by applying NLP on text corresponding to the target user account 150T. For example, the NLP module 410 applies NLP on text of the network objective 154 of the target user account 150T corresponding to “I want to learn how to fly a plane” to generate the target NLU output 412a. In this example, the NLP module 410 also applies NLP on text of the second user account 150b corresponding to “airline pilot” to generate the candidate NLU output 412b. Here, the comparer 420 generates a matching score 422 using the target NLU output 412a and the candidate NLU output 412b by comparing the semantic representations. That is, the comparer 420 is able to determine (i.e., understand) that the user associated with the second user account 150b being an airline pilot may be able to help the user associated with the target user account 150T achieve its network objective 154 of learning to fly a plane. Thus, in this example, the comparer 420 generates the networking recommendation 425 based on determining that the matching score 422 satisfies the matching score threshold.

Referring now to FIG. 4B, the NLP module 410 of an example neural network model 400, 400b receives the target user account 150T and the second user account 150b. The NLP module 410 generates the target NLP output 412 corresponding to the target user account 200T by applying NLP on text corresponding to the target user account 150T. For example, the NLP module 410 applies NLP on text of the network objective 154 of the target user account 150T corresponding to “I want to learn how to fly a plane” to generate the target NLU output 412a. In this example, the NLP module 410 also applies NLP on text of the second user account 150b corresponding to “fly fisherman” to generate the candidate NLU output 412b. Here, the comparer 420 generates a matching score 422 using the target NLU output 412a and the candidate NLU output 412b by comparing the semantic representations. That is, the comparer 420 is able to determine (i.e., understand) that the user associated with the second user account 150b being an fly fisherman would likely not be able to help the user associated with the target user account 150T achieve its network objective 154 of learning to fly a plane. Thus, in this example, the comparer 420 does not generate the networking recommendation 425 based on determining that the matching score 422 fails to satisfy the matching score threshold denoted by the “X” shown in FIG. 4B.

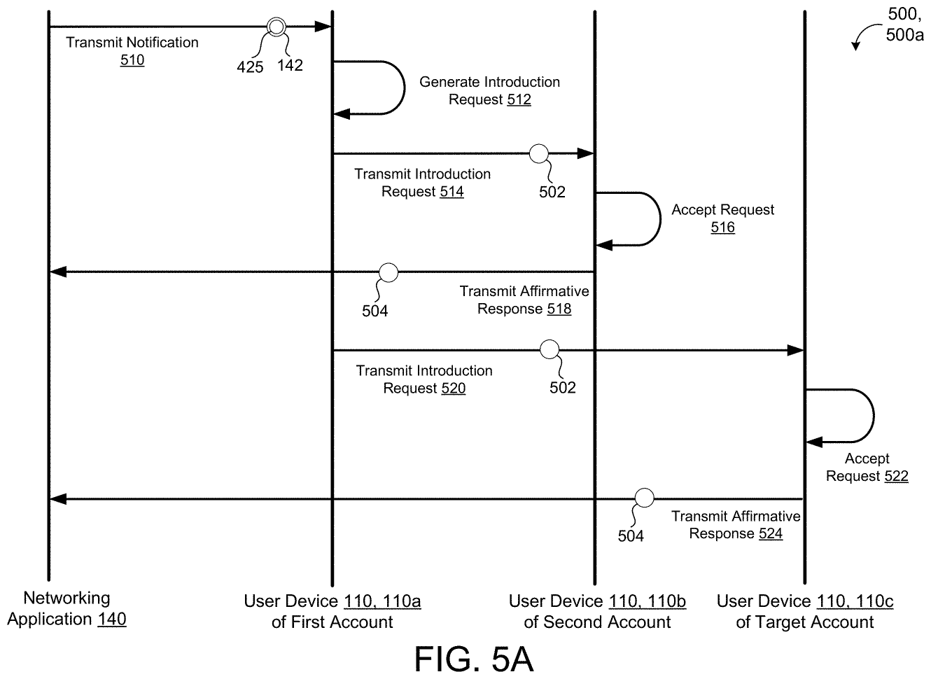

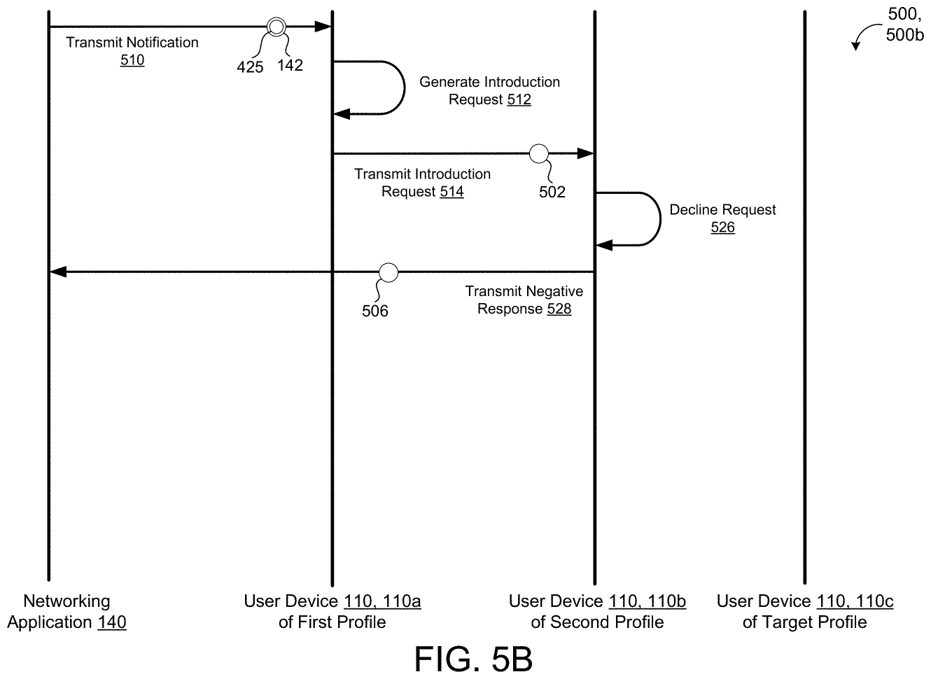

FIGS. 5A and 5B show an example sequence diagram 500 including steps for generating a primary connection (FIG. 5A), or not generating the primary connection (FIG. 5B), between the target user account 150T and the second user account 150b. The steps begin at the top of the Y-axis (i.e., the earliest point in time) and proceed in order down the Y-axis. The order of steps is exemplary only, as it is understood that the steps may occur in any order and one or more of the steps may occur simultaneously. The parallel vertical lines represent the networking application 140, a first user device 110, 110a associated with the first user account 150a, a second user device 110, 110b associated with the second user account 150b, and a third user device 110, 110c associated with the target user account 140T, respectively.

Referring now to FIG. 5A that shows an example sequence diagram 500, 500a. At step 510, when the networking application 140 generates the networking recommendation 425, the networking application 140 transmits the notification 142 including the networking recommendation 425 to the first user device 110a. For example, the notification 142 may indicate to the user associated with the first user account 150a that the second user account 150b and lacks a primary relationship with the target user account 150T. Moreover, the notification 142 indicates that the user associated with the second user account 150b may be able to help the user associated with the target user account 150T achieve one of its network objectives 154.

At step 512, the first user device 110a may generate the introduction request 502 based on user input. That is, the user associated with the first user account 150a provides user input at the first user device 110a to generate (or not generate) an introduction request 502. The introduction request 502 may indicate that the user associated with the first user account 150a wants to initiate an introduction between the user associated with the target user account 150T and the user associated with the second user account 150b. Each user may accept or deny the introduction request 502 by providing user input at their respective user device 110.

At step 514, the first user device 110a may transmit the introduction request 502 to the second user device 110b. Alternatively, the first user device 110a may transmit the introduction request 502 to the networking application 140 and the networking application 140 may forward the introduction request 502 to the second user device 110b (not shown). At step 516, the user associated with the second user account 150b may accept the introduction request 502 by providing an affirmative response 504 to the second user device 110b. At step 518, the second user device 110b transmits the affirmative response 504 to the networking application 140.

Similarly steps 514-518 are repeated for the target user account 150T. Namely, at step 520, the first user device 110a may transmit the introduction request 502 to the third user device 110c. At step 522, the user associated with the target user account 150T may accept the introduction request 502 by providing an affirmative response 504 to the third user device 110c. At step 524, the third user device 110c transmits the affirmative response 504 to the networking application 140. As such, based on the networking application 140 receiving the affirmative responses 504 from both the second user account 150b and the target user account 150T (e.g., double opt-in), the networking application 140 generates a primary relationship (e.g., primary connection 156) between the second user account 150b and the target user account 150T.

Referring now to FIG. 5B that shows an example sequence diagram 500, 500b. Here, steps 510-514 are identical to FIG. 5A. At step 526, however, the user associated with the second user account 150b may reject the introduction request 502 by providing a negative response 506 to the second user device 110b. At step 528, the second user device 110b transmits the negative response 506 to the networking application 140. Notably, based on the networking application 140 receiving the negative response 506 from the second user device 110b, the networking application 140 will not generate a primary connection 156 between the second user account 150b and the target user account 150T. That is, because generating the primary connection 156 requires an affirmative response from both user accounts 150, if either user account 150 provides the negative response 506 the networking application will not generate the primary connection 156.

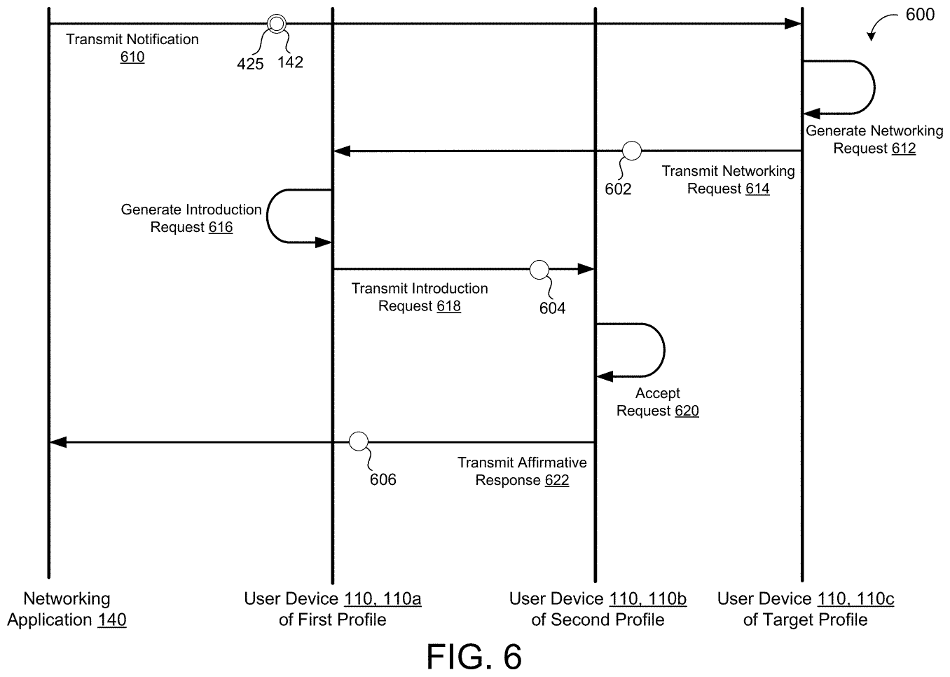

FIG. 6 shows another example sequence diagram 600 including steps for generating a primary between the target user account 150T and the second user account 150b. The steps begin at the top of the Y-axis (i.e., the earliest point in time) and proceed in order down the Y-axis. The order of steps is exemplary only, as it is understood that the steps may occur in any order and one or more of the steps may occur simultaneously. The parallel vertical lines represent the networking application 140, a first user device 110, 110a associated with the first user account 150a, a second user device 110, 110b associated with the second user account 150b, and a third user device 110, 110c associated with the target user account 140T, respectively.

At step 610, when the networking application 140 generates the networking recommendation 425, the networking application 140 transmits the notification 142 including the networking recommendation 425 to the third user device 110a. For example, the notification 142 may indicate to the user associated with the target user account 150T that the user associated with the first user account 150a has a primary relationship with the user associated with the second user account 150b. Moreover, the notification may indicate that user associated with the second user account 150b may be able to help the user associated with the target user account 150T achieve its network objective 154.

At step 612, the third user device 110c may generate the networking request 602 based on user input. The networking request 602 may indicate to the user associated with the first user account 150a that the user associated with the target user account 150T wants an introduction with the user associated with the second user account 150b. Notably, because the target user account 150T lacks a primary relationship with the second user account 150b, the target user account 150T is unable to directly request a connection with the second user account 150b. Instead, the introduction must be facilitated by mutual connection that both user profiles have with the first user account 150a.

At step 614, the third user device 110c may transmit the networking request 602 to the first user device 110a. Alternatively, the third user device 110c may transmit the networking request 602 to the networking application 140 and the networking application 140 may forward the networking request 602 to the first user device 110a (not shown). At step 616, the first user device 110a may generate an introduction request 604 based on user input. That is, the user associated with the first user account 150a provides user input at the first user device 110a to generate (or not generate) the introduction request 604. The introduction request 604 may indicate that the user associated with the first user account 150a wants to initiate an introduction between the user associated with the target user account 150T and the user associated with the second user account 150b.

At step 618, the first user device 110a may transmit the introduction request 604 to the second user device 110b. Alternatively, the first user device 110a may transmit the introduction request 604 to the networking application 140 and the networking application 140 may forward the introduction request 604 to the second user device 110b (not shown). At step 620, the user associated with the second user account 150b may accept the introduction request 604 by providing an affirmative response 606 to the second user device 110b. At step 622, the second user device 110b transmits the affirmative response 606 to the networking application 140. Here, the networking application 140 may generate the primary connection 156 between the target user account 150T and the second user account 150b based on consent from both user accounts. That is, because the target user account 150T generated the networking request 602 and the second user account 150b accepted the introduction request 604, both user accounts 150 have consented to the introduction.

Accordingly, as described above, the networking application 140 identifies secondary connections 158 with other user profiles 152 that may match the network objective 154 of the target user account 150T. Even though the target user account 150T lacks a primary relationship with the other user profiles 152 of the secondary connections 158, both the target user account 150T and the other user profiles (e.g., a second user account 150b) include a shared primary connection 158 with a first user account 150a. As such, the networking application 140 may prompt the first user account 150a, via the notification 142, to initiate an introduction between the target user account 150T and the second user account 150b.

Advantageously, the initiated introduction from a mutual connection simulates the experience of an in-person networking experience. Moreover, the networking application 140 only generates the notification 142 including the networking recommendation 245 when the text of the second user account 150b sufficiently matches the text of the networking objective 154 of the target user account 150T. The networking recommendation must be accepted by both user accounts 150 (e.g., double opt-in required) whereby one of the user accounts cannot establish the connection alone. User accounts 150 cannot view information with other user accounts they do not have a primary relationship with. That is, user accounts can only view information of other user accounts that they do have a primary relationship with.

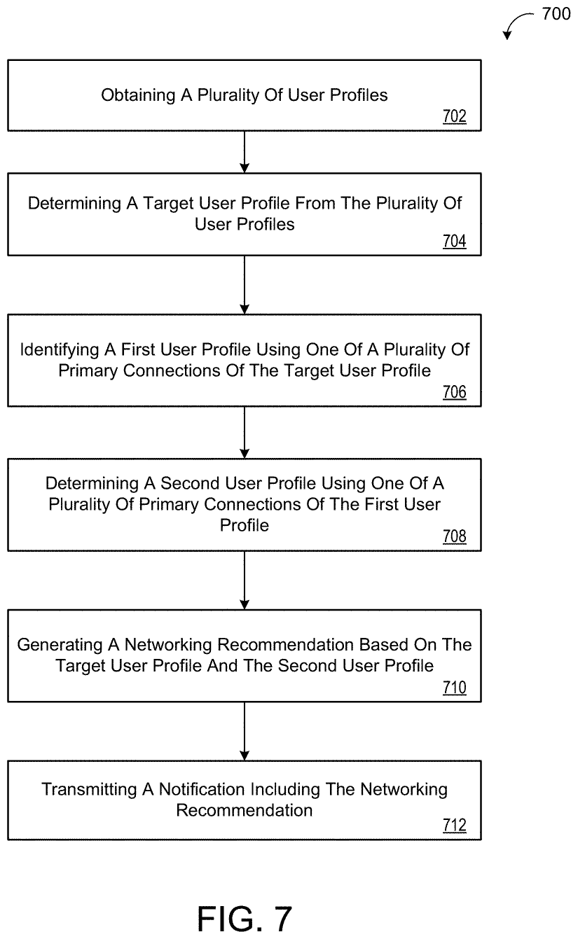

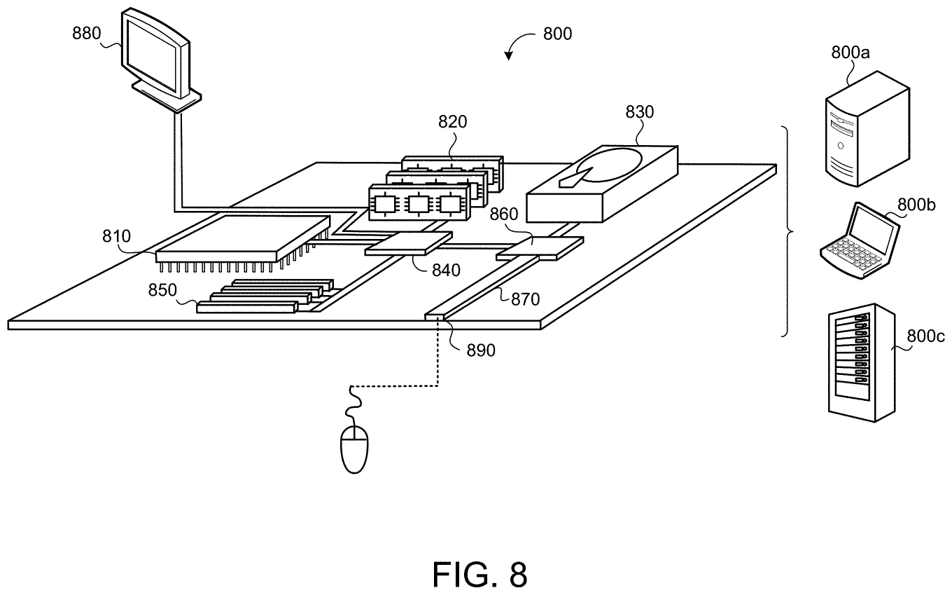

FIG. 7 is a flowchart of an example arrangement of operations for a computer-implemented method 700 of generating a networking recommendation for a user profile. The method 700 may execute on data processing hardware 810 (FIG. 8) using instructions stored on memory hardware 820 (FIG. 8). The data processing hardware 810 and the memory hardware 820 may reside on the user device 110 and/or the cloud computing environment 130 of FIG. 1 corresponding to a computing device 800 (FIG. 8).

At operation 702, the method 700 includes obtaining a plurality of user accounts 150, 150a-n. Here, each respective user account 150 of the plurality of user account includes a user profile, a network goal 154, and a plurality of primary connections 156. Each primary connection 156 defines a primary relationship between the respective user profile 152 and a different user account 150 of the plurality of user accounts 150. At operation 704, the method 700 includes determining a target user account 152, 150T from the plurality of user accounts 150. At operation 706, the method 700 includes identifying a first user account 152, 150a using one of the plurality of primary connections 156 of the target user account 150T. At operation 708, the method 700 includes determining a second user account 152, 150b using one of the plurality of primary connections 156 of the first user account 150a. At operation 710, the method 700 includes generating a networking recommendation 425 based on text corresponding to the network objective 154 of the target user account 150T and text corresponding to the second user account 150b. At operation 712, the method 700 includes transmitting a notification 142 that includes the networking recommendation 425 to a user device 110 associated with the first user account 150a.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

FIG. 8 is schematic view of an example computing device 800 that may be used to implement the systems and methods described in this document. The computing device 800 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 800 includes a processor 810, memory 820, a storage device 830, a high-speed interface/controller 840 connecting to the memory 820 and high-speed expansion ports 850, and a low speed interface/controller 860 connecting to a low speed bus 870 and a storage device 830. Each of the components 810, 820, 830, 840, 850, and 860, are interconnected using various busses, and may be mounted on a common motherboard or in other manners as appropriate. The processor 810 can process instructions for execution within the computing device 800, including instructions stored in the memory 820 or on the storage device 830 to display graphical information for a graphical user interface (GUI) on an external input/output device, such as display 880 coupled to high speed interface 840. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 820 stores information non-transitorily within the computing device 800. The memory 820 may be a computer-readable medium, a volatile memory unit(s), or non-volatile memory unit(s). The non-transitory memory 820 may be physical devices used to store programs (e.g., sequences of instructions) or data (e.g., program state information) on a temporary or permanent basis for use by the computing device 800. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 830 is capable of providing mass storage for the computing device 800. In some implementations, the storage device 830 is a computer-readable medium. In various different implementations, the storage device 830 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 820, the storage device 830, or memory on processor 810.

The high speed controller 840 manages bandwidth-intensive operations for the computing device 800, while the low speed controller 860 manages lower bandwidth-intensive operations. Such allocation of duties is exemplary only. In some implementations, the high-speed controller 840 is coupled to the memory 820, the display 880 (e.g., through a graphics processor or accelerator), and to the high-speed expansion ports 850, which may accept various expansion cards (not shown). In some implementations, the low-speed controller 860 is coupled to the storage device 830 and a low-speed expansion port 890. The low-speed expansion port 890, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 800a or multiple times in a group of such servers 800a, as a laptop computer 800b, or as part of a rack server system 800c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method when executed by data processing hardware causes the data processing hardware to perform operations comprising:
obtaining a plurality of user accounts of a platform, each respective user account of the plurality of user accounts comprising:
a user profile;
a network strategy comprising at least one of current connections, candidate connections, network goals, networking tasks, networking events, networking introductions, candidate introductions, and an ability to invite users to the platform; and
a plurality of primary connections, each primary connection of the plurality of primary connections defining a primary relationship between the respective user account and a different user account of the plurality of user accounts;
determining a target user account from the plurality of user accounts;
identifying, using one of the plurality of primary connections of the target user account, a first user account;
determining, using one of the plurality of primary connections of the first user account, a second user account, the second user account lacking a primary relationship with the target user account;
generating, based on text corresponding to the network goals of the target user account and text corresponding to the second user account, a networking recommendation; and
transmitting, to a user device associated with the first user account, a notification comprising the networking recommendation.

2. The computer-implemented method of claim 1, wherein the operations further comprise transmitting, to a user device associated with the target user account, the notification comprising the networking recommendation.

3. The computer-implemented method of claim 1, wherein the networking recommendation comprises a recommendation for a user associated with the first user account to initiate an introduction between a user associated with the target user account and a user associated with the second user account.

4. The computer-implemented method of claim 3, wherein the operations further comprise:
receiving, from the user device associated with the first user account, an introduction request to initiate the introduction between the user associated with the target user account and the user associated with the second user account; and
transmitting, to a user device associated with the target user account and a user device associated with the second user account, the introduction request.

5. The computer-implemented method of claim 4, wherein the operations further comprise:
receiving an affirmative response from both the user device associated with the target user account and the user device associated with the second user account; and
generating a primary connection between the target user account and the second user account based on receiving the affirmative responses from both the user device associated with the target user account and the user device associated with the second user account.

6. The computer-implemented method of claim 4, wherein the operations further comprise:
receiving at least one negative response from either the user device associated with the target user account or the user device associated with the second user account; and
determining not to generate a primary connection between the target user account and the second user account based on receiving the at least one negative response from either the user device associated with the target user account or the user device associated with the second user account.

7. The computer-implemented method of claim 1, wherein determining the networking recommendation comprises:
generating, using a neural network model, a target natural language processing (NLP) output corresponding to the text of the network goal of the target user account;
generating, using the neural network model, a candidate NLP output corresponding to the text of the second user account; and
determining a matching score using the target NLP output and the candidate NLP output.

8. The computer-implemented method of claim 7, wherein the operations further comprise:
determining that the matching score satisfies a matching score threshold; and
transmitting the notification comprising the networking recommendation based on determining that the matching score satisfies the matching score threshold.

9. The computer-implemented method of claim 1, wherein the operations further comprise training a neural network model.

10. The computer-implemented method of claim 1, wherein each respective user account of the plurality of user accounts further comprises a plurality of spheres of influence, each respective sphere of influence comprising:
at least one primary connection of the plurality of primary connections;
a classification representing a connection type of each primary connection of the at least one primary connections; and
for each respective primary connection of the at least one primary connection, a ranking indicating a connection strength.

11. A system comprising:
data processing hardware; and
memory hardware in communication with the data processing hardware, the memory hardware storing instructions that when executed on the data processing hardware cause the data processing hardware to perform operations comprising:
obtaining a plurality of user accounts of a platform, each respective user account of the plurality of user accounts comprising:
a user profile;
a network strategy comprising at least one of current connections, candidate connections, network goals, networking tasks, networking events, networking introductions, candidate introductions, and an ability to invite users to the platform; and
a plurality of primary connections, each primary connection of the plurality of primary connections defining a primary relationship between the respective user account and a different user account of the plurality of user accounts;
determining a target user account from the plurality of user accounts;
identifying, using one of the plurality of primary connections of the target user account, a first user account;
determining, using one of the plurality of primary connections of the first user account, a second user account, the second user account lacking a primary relationship with the target user account;
generating, based on text corresponding to the network goals of the target user account and text corresponding to the second user account, a networking recommendation; and
transmitting, to a user device associated with the first user account, a notification comprising the networking recommendation.

12. The system of claim 11, wherein the operations further comprise transmitting, to a user device associated with the target user account, the notification comprising the networking recommendation.

13. The system of claim 11, wherein the networking recommendation comprises a recommendation for a user associated with the first user account to initiate an introduction between a user associated with the target user account and a user associated with the second user account.

14. The system of claim 13, wherein the operations further comprise:
receiving, from the user device associated with the first user account, an introduction request to initiate the introduction between the user associated with the target user account and the user associated with the second user account; and
transmitting, to a user device associated with the target user account and a user device associated with the second user account, the introduction request.

15. The system of claim 14, wherein the operations further comprise:
receiving an affirmative response from both the user device associated with the target user account and the user device associated with the second user account; and
generating a primary connection between the target user account and the second user account based on receiving the affirmative responses from both the user device associated with the target user account and the user device associated with the second user account.

16. The system of claim 14, wherein the operations further comprise:
receiving at least one negative response from either the user device associated with the target user account or the user device associated with the second user account; and
determining not to generate a primary connection between the target user account and the second user account based on receiving the at least one negative response from either the user device associated with the target user account or the user device associated with the second user account.

17. The system of claim 11, wherein determining the networking recommendation comprises:
generating, using a neural network model, a target natural language processing (NLP) output corresponding to the text of the network goal of the target user account;
generating, using the neural network model, a candidate NLP output corresponding to the text of the second user account; and
determining a matching score using the target NLP output and the candidate NLP output.

18. The system of claim 17, wherein the operations further comprise:
determining that the matching score satisfies a matching score threshold; and
transmitting the notification comprising the networking recommendation based on determining that the matching score satisfies the matching score threshold.

19. The system of claim 11, wherein the operations further comprise training a neural network model.

20. The system of claim 11, wherein each respective user account of the plurality of user accounts further comprises a plurality of spheres of influence, each respective sphere of influence comprising:
at least one primary connection of the plurality of primary connections;
a classification representing a connection type of each primary connection of the at least one primary connections; and
for each respective primary connection of the at least one primary connection, a ranking indicating a connection strength.
